(19) United States
(12) Patent Application Publication
(10) Pub. No.: US 2025/0031641 A1
(43) Pub. Date: Jan. 30, 2025

(54) GROWING SYSTEM FOR HYDROPONICS

(71) Applicant: RIJK ZWAAN ZAADTEELT EN ZAADHANDEL B.V., De Lier (NL)

(72) Inventor: Pieter Cornelis SONNEVELD, De Lier (NL)

(21) Appl. No.: 18/788,684

(22) Filed: Jul. 30, 2024

Related U.S. Application Data
(63) Continuation-in-part of application No. PCT/EP2023/052448, filed on Feb. 1, 2023.

(30) Foreign Application Priority Data
Feb. 1, 2022 (NL) 2030805

(51) Int. Cl. A01G 31/02; A01C 1/04; A01G 27/06

(52) U.S. Cl. CPC A01G 31/02; A01C 1/042; A01G 27/06

(57) ABSTRACT

The present invention relates to a growing system for hydroponics, comprising a gutter and a tape, wherein the gutter is open at the top and comprises a receptacle for a fluid that extends along the longitudinal direction of the gutter and wherein the tape is fixed in the gutter in an upright position in the longitudinal direction of the gutter and partially extends beyond the open top and wherein the tape is for holding or supporting propagating material. The propagating material comprises for example seeds, germinated seeds, seedlings, plantlets or cuttings. In use, the tape is in contact with a fluid in the receptacle for wicking the fluid through the tape. In a preferred embodiment, the tape comprises at least two layers that are partially held together but are preferably not held together at the part that extends beyond the open top of the gutter. The invention further relates to a method of growing plants using the growing system.

### RELATED APPLICATIONS AND INCORPORATION BY REFERENCE

This application is a continuation-in-part of copending International Patent Application No. PCT/EP2023/052448, filed Feb. 1, 2023, and published as International Publication No. WO 2023/148223 on Aug. 10, 2023 and which claims priority to International Application No. NL 2030805, filed Feb. 1, 2022, the contents of which are incorporated by reference herein in their entirety.

The foregoing applications, and all documents cited therein or during their prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The present invention relates to a growing system for hydroponics and to a method for growing plants on hydroponics.

### BACKGROUND OF THE INVENTION

Hydroponics is a type of horticulture which involves growing plants, usually crops, without soil. For growth, plants need water, light and nutrients. In hydroponics, the necessary nutrients are not provided by soil but by a mineral nutrient solution in an aqueous solvent, in particular water.

Different forms of hydroponics exist. Vegetable growers often use gutter systems, also called NFT (Nutrient Film Technique) system for growing plants on hydroponics on a large scale. The use of gutters allows for the growing of a large number of plants in a fully or semi-automated system. Irrigation occurs through a central system that provides water to each gutter. The water runs from one end of the gutter to the other end, as one end of the gutter is usually slightly tilted with respect to its other end.

Plants may grow with their roots exposed to the nutrient solution, or, alternatively, the roots may be physically supported by an inert growth medium such as perlite, gravel, or other inert loose substrates, or the plants are grown in substrate units, such as pressed peat blocks, plastic, paper or polyurethane cups filled with peat/turf/perlite/mixed substrates or in rock mineral wool, polyurethane foam or oasis which are in contact with the nutrient solution.

The problem with some of these systems, especially when growing plants in high densities, is that during growth the gutter fills up with the growth medium and the growing roots. As a result, the water flow becomes blocked towards the end of the growing cycle. This may affect the growth of the plants. Also, the water content in the growing medium may not be uniformly divided throughout the gutter resulting in less uniformity in plant growth.

Other problems associated with using a growth medium in gutter systems is that the growth medium may pollute the growing system and may contaminate the plants with residues of the substrates. Also, phytosanitary contamination risks could occur by using some types of substrates. Further problems associated with the use of growth medium in hydroponic systems are the logistic activities required for the transport of large volumes of growth medium to and from the growers, which have an impact on the environment, and the disposal of the growth medium after the growing cycle and, in general, the growth medium is relatively expensive in relation to the intended production.

### SUMMARY OF THE INVENTION

Since it is not possible to position seeds or small plants in a gutter without any form of support, it is the object of the present invention to provide an alternative for the inert growth media that are currently used.

According to ones aspect of the invention, the present invention provides for a growing system for hydroponics, comprising a gutter and a tape, wherein the gutter is open at the top and comprises a receptacle for a fluid that extends along the longitudinal direction of the gutter and wherein the tape is fixed in the gutter in an upright position in the longitudinal direction of the gutter and partially extends beyond the open top and wherein the tape is for holding and/or supporting propagating material.

In some embodiments, the propagating material comprises seeds, germinated seeds, seedlings, plantlets or cuttings.

In some embodiments, the tape is in contact with a fluid in the receptacle for wicking the fluid through the tape when the growing system is in use.

In some embodiments, the tape comprises at least two layers that are partially held together but are preferably not held together at the part that extends beyond the open top of the gutter. In some embodiments, the at least two layers are held together by gluing the layers together, by sewing the layers together, by fusing the layers by means of heat, by folding, by clamping, or by any other means.

In some embodiments, the tape is a seed tape comprising a number of seeds located along its length, preferably at a predetermined distance from each other.

In some embodiments, the seeds are located in between the at least two layers at a position where the layers are held together. In some embodiments, the layers are held together such that the seeds once germinated are able to emerge from between the layers.

In some embodiments, the tape forms a platform for supporting seeds or germinated seeds.

In some embodiments, the tape comprises pockets for holding seedlings, plantlets or cuttings.

In some embodiments, the tape is fixed in the gutter by clamping means located at the open top. In some embodiments, the tape is fixed in the gutter by adherence of the at least two layers extending beyond the open top of the receptacle to the gutter.

In some embodiments, the gutter is provided along its length with a guiding element extending from one side of the open top into the gutter interior.

In some embodiments, the propagation material comprises seeds, germinating seeds, seedlings, plantlets or cuttings of vegetables in particular, leafy vegetables, more in particular lettuce.

According to another aspect of the invention, the present invention provides for a method for growing plants, comprising providing plant propagation material in the growing system as described herein and allowing the propagation material to develop into plants, preferably until harvest stage.

In some embodiments, the method comprises the steps of
a) providing propagation material held in or supported by a tape located upright in a gutter with an open top, wherein the tape comprises at least two layers partially extending beyond the open top, wherein the tape is fixed in the gutter by adherence of the at least two layers of the part of the tape extending beyond the open top to the outside of the gutter; and
b) allowing the propagation material to grow into harvestable plants.

In some embodiments, the plants are vegetable plants. In some embodiments, the vegetable plants are leafy vegetable plants. In some embodiments, the leafy vegetable plants are lettuce plants.

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. § 112(a)) or the EPO (Article 83 of the EPC), such that Applicants reserve the right and hereby disclose a disclaimer of any previously described product, process of making the product, or method of using the product. It may be advantageous in the practice of the invention to be in compliance with Art. 53(c) EPC and Rule 28(b) and (c) EPC. All rights to explicitly disclaim any embodiments that are the subject of any granted patent(s) of applicant in the lineage of this application or in any other lineage or in any prior filed application of any third party is explicitly reserved. Nothing herein is to be construed as a promise.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following detailed description, given by way of example, but not intended to limit the invention solely to the specific embodiments described, may best be understood in conjunction with the accompanying drawings.

FIG. 1 is a perspective view of an embodiment of a hydroponics system of the invention comprising a seed tape.

FIG. 2 is a perspective view of a seed tape of the invention.

FIG. 3 is an embodiment of a hydroponics system of the invention comprising a sowing platform and a guiding element.

FIG. 4 is a cross-sectional view of the embodiment shown in FIG. 3.

FIGS. 5-14 are cross-sectional views of alternatives of the embodiment shown in FIG. 1 with different gutter shapes.

FIGS. 15-19 are cross-sectional views of alternatives of the embodiment shown in FIG. 3 with different gutter shapes.

FIGS. 20-23 shows cross-sectional views of various configurations of the tape.

FIGS. 24-29 show various alternatives of holding the lower part of the tape together to support seeds.

FIGS. 30A and 30B provide an overview of an experiment using the growing system to germinate seeds in a hydroponics system.

FIG. 31 shows an alternative way of preparing a seeds tape for use in the growing system of the invention.

### DETAILED DESCRIPTION OF THE INVENTION

The invention relates to a growing system for hydroponics, comprising a gutter and a tape, wherein the gutter is open at the top and comprises a receptacle for a fluid that extends along the longitudinal direction of the gutter and wherein the tape is fixed in the gutter in an upright position in the longitudinal direction of the gutter and partially extends beyond the open top and wherein the tape is for holding and/or supporting propagating material.

The gutter can have different shapes. In cross section the gutter can be round, square, rectangular, triangular, diamond-shaped, house-shaped or combinations thereof. In a triangular gutter, the base of the triangle can be at the bottom of the gutter or at the top. The width of the gutter should be such that even after a root system has formed sufficient nutrient fluid can reach all plants in the gutter. Usually, these gutters are not permanently filled with water, but a flow of nutrient solution is intermittently provided to the gutters from one side. As the gutters are slightly tilted the water will then flow to the lower part along the tape and developing roots. In order to facilitate this flow, shapes that have a broad base are preferred. How far a root system after germination extends into the gutter and whether it potentially blocks the gutter also depends on the type of crop and the developmental stage of the plants.

After germination, the developing root may have the tendency to grow outside the tape. Since in early stages of development, the root is not long enough to reach the nutrient solution and the root thus depends on the tape to provide the fluid that is needed to grow, growing outside the tape may lead to drying out of the root tip or the whole root leading to damage to the plant, as growth is affected. If the root dries out completely, the seedling may even die. In order to guide the root of the germinating seed, the gutter may be provided with a guiding element, that is preferably positioned along the length of the gutter and extends from one side of the open top to the inside of the gutter, preferably forming an angle with the gutter wall. This angle can be anything deviating from perpendicular in relation to the bottom of the gutter, but is preferably 10 to 80°, more preferably 20 to 70°, even more preferable 30 to 70°, most preferably about 45 to 55°.

The tape is suitable as a support for various types of propagating material, in particular seeds, germinated seeds, seedlings, plantlets or cuttings. The word “tape” is used herein to indicate a support that is elongated in shape and which is much longer than wide. The word “tape” is used herein in the same or similar sense as a seed tape although according to the invention not all such tapes actually need to comprise seeds. The word “tape” is thus also used in the context of a support that is configured to form a platform as described herein.

The tape comprises at least two layers that are partially held together but are preferably not held together at the part that extends beyond the open top of the gutter.

The layers are suitably made of a material that has wicking properties and the tape as a whole preferably has sufficient tensile strength to remain intact when pulled into and/or through the gutter, also when wet. Alternatively, the tape can be positioned in the gutter by pushing it through the open top.

Preferably, the tape is biodegradable, but it also has to be sufficiently durable to remain intact while the seeds are in the process of germinating and have not yet established sufficiently in the gutter. Once a seedling is established in the gutter and can independently maintain its position, the tape is no longer needed and can disintegrate.

The tape comprises at least two layers that are partially held together but are preferably not held together at the part that extends beyond the open top of the gutter.

The part of the tape that is held together comprises the plant material. The plant material, in particular seeds, are thus held at a predetermined position.

Holding the at least two layers together can be achieved by various means, such as by gluing the layers together, by sewing the layers together, by fusing the layers by means of heat, by folding, by clamping, or by any other means.

The two layers of the tape need not be separate but may also be formed by folding a broader strip of tape material along its length, preferably in half. The fold is the base of the part of the tape that is in contact with the fluid. In one embodiment, the tape is folded to form a receptacle for the seeds. Such configuration can have partial cut-outs that are folded to come into contact with the nutrient solution. Alternatively, the tape can be folded such that seeds are clamped in between the layers.

The opposite side of the tape extends beyond the open top and can be folded over. Other folding arrangements can be envisaged.

The means for holding the layers together should be such that the germinating seed and developing plant can penetrate the holding means to reach the nutrient solution and the outside of the gutter. The layers are, for example, held together such that the roots and cotyledons of the germinated seeds are able to emerge from between the layers. Therefore, the glue, stitches, fusion pattern, fold, or clamps should be arranged such that the various parts of the germinating seeds are able to penetrate them or the space surrounding them. A glue can for example be applied in an intermittent pattern such that the roots and plants can penetrate in between the discrete glue patches. As an alternative, a glue can be used that gradually dissolves or can be broken down by the root exudate. When sealing the tape material together with heat the seal is preferably not continuous but is interrupted, preferably near the location of the seeds. The size of the stitches can be such that the distance is sufficient to allow the passage of the roots and plant. Folds should not obstruct the passage to the outside of the gutter. Clamps are preferably soft and slightly spaced to allow the plants to grow in between them.

Usually, the part of the tape that comprises the seeds is located in the gutter. However, in some embodiments, it is preferred that the seeds are located outside the gutter, i.e., beyond the open top, for example when the tape is clamped. In that case, the part of the tape that is held together also extends partially beyond the open top so that the plants are not hindered by the clamping means. This is the part that comprises the seeds.

In one embodiment, the tape is a seed tape comprising a number of seeds located along its length, preferably at a predetermined distance from each other. The seeds are preferably located in between the at least two layers at a position where the layers are held together. As an alternative, the tape may consist of only one layer to which the seeds are fixed, for example by means of a glue.

In an alternative embodiment, the tape forms a platform for receiving seeds or germinated seeds. In this embodiment, the seeds are not integrated in the tape but are placed on a sowing platform formed by the tape. The grower can then determine the desired distance between the seeds depending on the growing density. The platform is configured such that the seeds do not fall of or fall through. In practice this means that a part of the layers that form the tape are held together or are fixed over part of their surface. Means for holding the layers together are the same as described above. Holding together the layers is then done over the part that does not form the platform. The held together part of the tape guides the nutrient solution from the receptacle to the platform to come in contact with the seeds. Roots of germinated seeds and developing seedlings, plantlets or cuttings should still be able to reach the nutrients solution to come into direct contact therewith. They should either penetrate in between the layers that are held together or grow outside these layers. The latter is less preferred as it may lead to the roots drying out.

In a further embodiment, the tape comprises pockets for receiving seedlings, plantlets or cuttings. The pockets can be discrete, or the tape is provided with a continuous pocket along its length in which the seedlings, plantlets or cuttings are positioned at the desired distance from each other.

In use, the tape is in contact with a fluid in the receptacle for wicking the fluid through the tape to provide the fluid to the plant material. The tape extends partially inside the gutter and partially outside the gutter. The parts inside the gutter are for wicking water from the receptacle to the plant material. The part outside the gutter, i.e. the part that extends beyond the open top of the gutter is suitably used to fixate the tape in the gutter.

In one embodiment, the tape is fixed in the gutter by clamping means located at the open top along the length of the gutter. The part of the tape extending beyond the top is then clamped to keep the tape in place in the gutter. Suitably, the clamping means are soft to avoid damage to the growing plant and to allow passage of the seedling through the open top of the gutter. Foam rubber, for example in the form of strips, or similar materials are well suited for forming the clamping means. Preferably, the seeds in the seed tape are located slightly above the foam rubber to avoid hindrance of the growing plant. In this latter configuration, the part of the tape that is held together may also extend partially above the open top of the gutter. Suitably, the seeds are located in the tape at a distance less than about 0.5 cm below the edges of the gutter that form the open top.

In another embodiment, the tape is fixed in the gutter by adherence of the at least two layers extending beyond the open top forming the arms of a T to the outside of the gutter. In this embodiment, no additional fixating means are necessary. The wet tape is fixed by capillary action to the gutter. It was found that this type of fixation works without additional means and was sufficient to keep the tape in place.

Suitably, the at least two layers of the tape form in cross section a T-shape. In this T-shape, the parts of the tape extending outside the gutter are positioned essentially horizontal to form the arms of the T. The part of the tape that is fixed upright inside the gutter forms the stem of the T. In the embodiment, wherein the arms of the T form a platform, the layers are held together in such a way that the seeds located on the supporting platform do not fall through. In the embodiment, wherein the tape comprises pockets, these are suitably comprised in the stem of the T. In all embodiments, the arms of the T may be positioned essentially horizontal when in use but can also be folded over or turned down depending on the configuration of the gutter.

In another embodiment, the arms of the T are further folded to form a W that is upside down or an M-shape. This shape is in particular suitable for gutters that have sloping walls, such as a triangle or a house-shape. The seed resides in the central part of the shape and the arms are for fixating the tape to the outside gutter walls.

The material of the tape should be able to wick water from the receptacle to the seeds or plants and, in some embodiments, the part extending beyond the top of the gutter to make it adhere to the gutter. The tape can for example be made of paper, woven or non-woven fabrics, polymers, plastic films or a mix thereof. Preferably, the tape is biodegradable but at the same time sufficiently durable during culture of the plants. Until the seedling or plantlet is large enough to be held by the open top of the gutter, it must preferably be supported by the tape.

The material should preferably not be susceptible to the growth of algae. Preferably, the tape material is algae repellent.

In an alternative embodiment, the tape in the gutter is not a continuous tape. Discrete pieces of tape each holding one or a small number of plants or seeds can be placed side by side in the gutter. The advantage is that less tape material is needed.

According to the invention, the seed can be attached to the tape or sown directly in between or on top of the tape. When sowing directly in between or on top of the tape, the seeds are not an integral part of the seed tape but separate therefrom. The grower can thus chose which tape to use.

The invention is suitable for all sorts of crops, in particular vegetable crops, more in particular leafy vegetables. In addition, the invention can be used in the field of ornamentals.

The invention is in particular useful for lettuce, especially for some stages of lettuce. Lettuce that is harvested at so-called “toddler stage” can be sown directly in the gutter and does not need to be transplanted to grow to harvestable stage. Toddler lettuce is the stage at which the leaves are not yet heading and the plants are 8-40 g. Harvest stage for toddler lettuce is usually between 20 and 30 days, in particular around 24 days. The invention is also suitable for the well-known baby leaf lettuce, which is smaller than toddler lettuce. Another category is teen lettuce. This stage is a bit bigger than toddler lettuce. The spacing between lettuce plants intended for harvesting teen lettuce is larger than for toddler lettuce. Teen lettuce can also be grown in the hydroponics system of the invention but to grow into teen lettuce the plants require more space. In order to still use the system of the invention, the tape in which the lettuce seeds are germinated can then preferably be cut into separate pieces each comprising one seedling. These tape pieces are then positioned in the gutter with a larger space in between seedlings.

If the seed tape comprises glue this may be pulled up through the tape by the water, for example by chromatographic action, and assist in fixating the tape to the outside of the gutter.

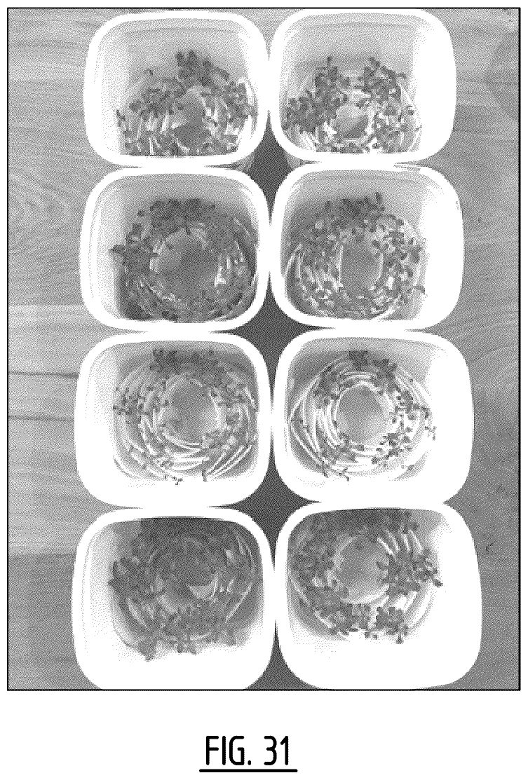

In a further embodiment, the seed tape can be pre-germinated before placement in the gutter. A particularly useful way of pre-germinating a seed tape is by placing a rolled-up or folded seed tape in a container with water and covering the container to provide favorable germination conditions. The pre-germination method is shown in FIG. 31.

In order to avoid that in this germination method, the developing roots from one part of the seed tape enter another part it is possible to provide a layer or spacer in between the different turns of the roll of between the folds. The layer or spacer are suitably impermeable to roots.

The seed tape must have sufficient tensile strength to be positioned in the gutter after germination is complete without being damaged or ruptured.

In a further embodiment, parts of the seed tape containing one or a low number of plants can be cut off and positioned in the gutter separately. This way, the desired spacing between the developing plants can be maintained from an early stage on.

The invention further relates to a method for growing plants, comprising providing plant propagation material in a growing system as described above and allowing the propagation material to develop into plants, preferably until harvest stage.

The invention also relates to a method for growing plant, comprising the steps of
a) providing propagation material held in or supported by a tape located upright in a gutter with an open top, wherein the tape comprises at least two layers partially extending beyond the open top, wherein the tape is fixed in the gutter by adherence of the at least two layers of the part of the tape extending beyond the open top to the outside of the gutter; and
b) allowing the propagation material to grow into harvestable plants.

The growing system of the present invention solves the problems encountered when using the substrate types usually applied in hydroponics. The tape is smaller and does not block the gutter and will have less influence on the waterflow. Contamination is avoided. The material is less expensive, and it leads to less waste and less environmental impact, costs and complexity of logistic activities.

The present invention will be further illustrated in the following figures and example that are given for illustration purposes only and are not intended to limit the invention in any way.

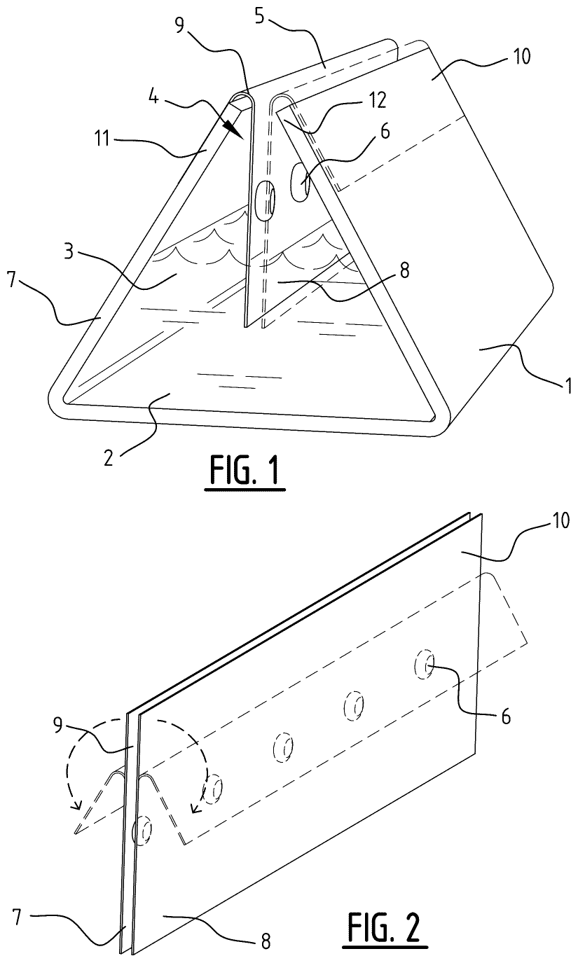

FIG. 1 shows a triangle-shaped gutter 1 that forms a receptacle 2 for the nutrient medium 3. The gutter has an open top 4. A seed tape 5 comprising seeds 6 is positioned upright in the gutter and is in contact with the nutrient solution. The seed tape 4 has two layers 7 and 8 that are held together at the lower part and are loose at the part extending beyond the open top 4. These parts 9 and 10 are folded over the edges 11 and 12 of the gutter 1 and adhere thereto by means of capillary action. The seeds are positioned in between the layers.

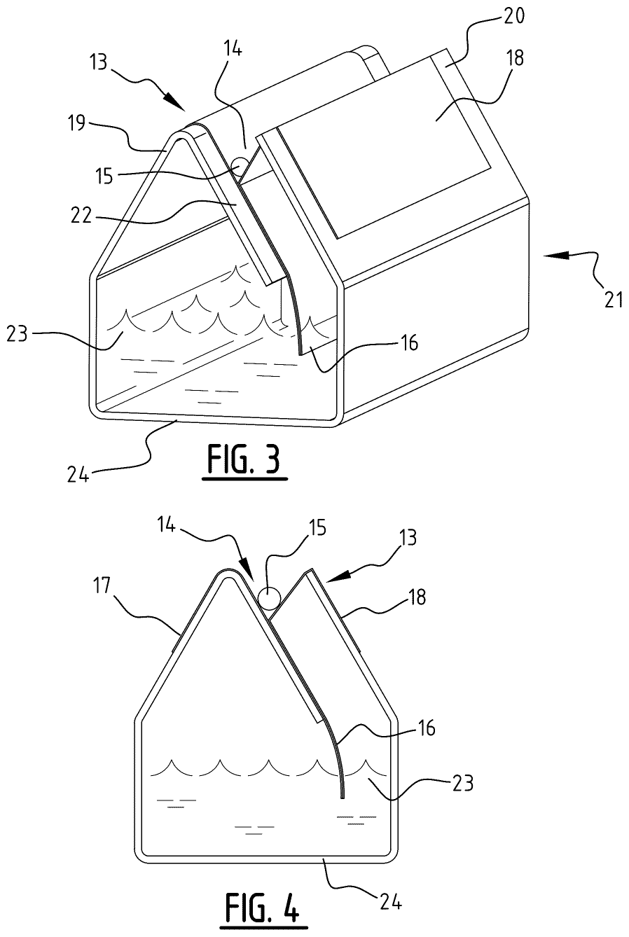

FIG. 2 is a schematic representation of the seed tape 5 showing the seeds 6 that are positioned at a predetermined distance.

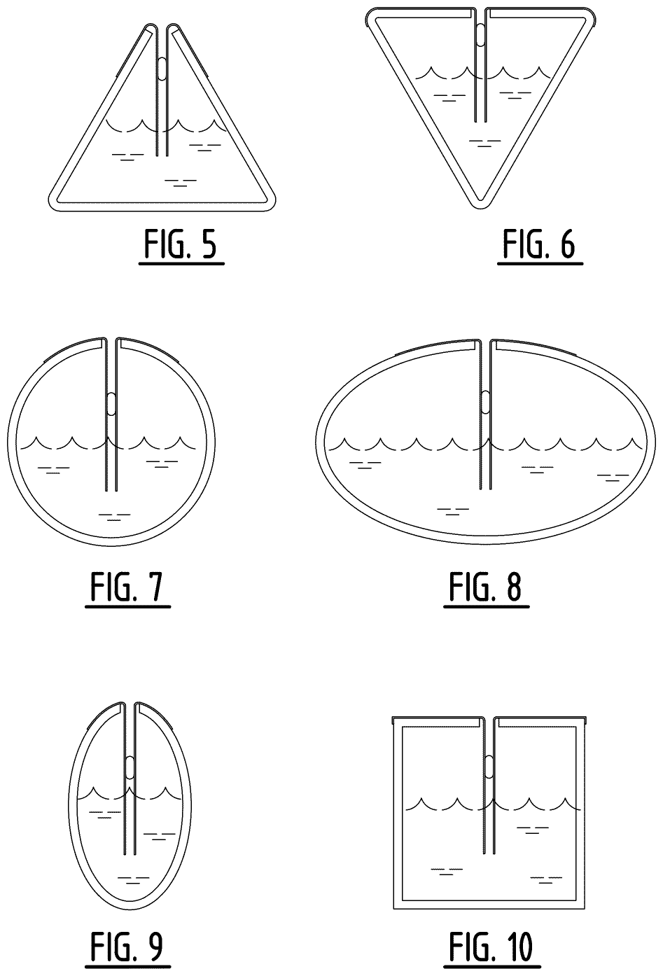

FIG. 3 shows an alternative embodiment in which the tape 13 forms a platform 14 for the seeds 15. The lower part 16 of the tape is held together to prevent the seeds 15 from falling through. This part 16 is in contact with the nutrient solution 23. The two layers 17 and 18 of the upper part of the tape are not held together and are folded over the side walls 19 and 20 of the house-shaped gutter 21. The layers 17 and 18 adhere to the outside walls 19 and 20 of the gutter 21 by capillary action. The gutter 21 further comprises a sloping guiding element 22 extending into the interior of the gutter 21 and guiding the lower part of the tape 16. This configuration enables guiding the developing root along the tape to avoid drying out of the root. In this configuration the tape 13 is slightly tilted instead of being located essentially perpendicular in relation to the bottom 24 of the gutter 21.

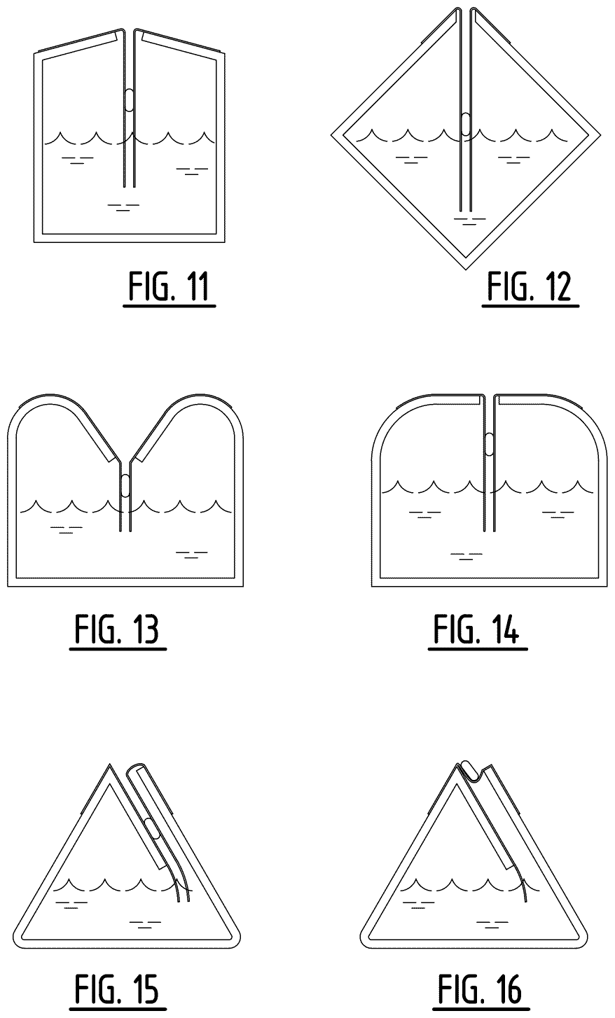

The embodiment of FIG. 3 is shown in cross-section in FIG. 4.

The embodiment shown in FIGS. 3 and 4 has the advantage that the part of the tape that extends beyond the open top is less prone to algae formation because it is guided downwards along the inclining side walls of the gutter and as a result receives less light than a more horizontal wall. In addition, because the walls are sloping, the first leaves after germination do not touch the wet tape. Furthermore, because of the sloping configuration of the upper part of the gutter, the plants are easier to harvest since there is sufficient space between the plant and the gutter to cut off the leaves. The rectangular bottom of the gutter allows the easy access and passage of nutrient solution. Moreover, the rectangular bottom part allows placement in existing gutter systems.

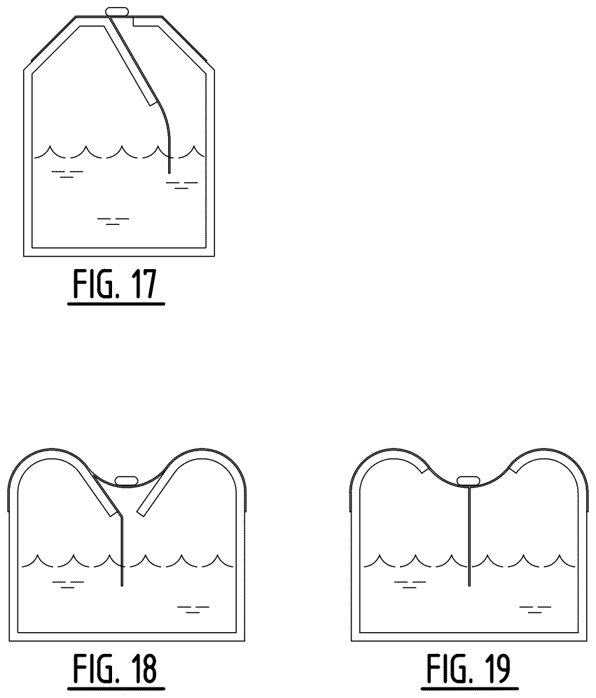

The embodiment shown in FIG. 5 is similar to the one in FIG. 1. A further triangular gutter is shown in FIG. 6. In the embodiments shown in FIGS. 7, 8 and 9 the cross-section of the gutter is round, a lying oval or a standing oval. FIG. 10 shows a square cross-section, whereas FIG. 11 is house-shaped, and FIG. 12 is diamond-shaped. In FIGS. 13 and 14 the upper parts of the gutter that define the open top are curved, whereas the bottom is square.

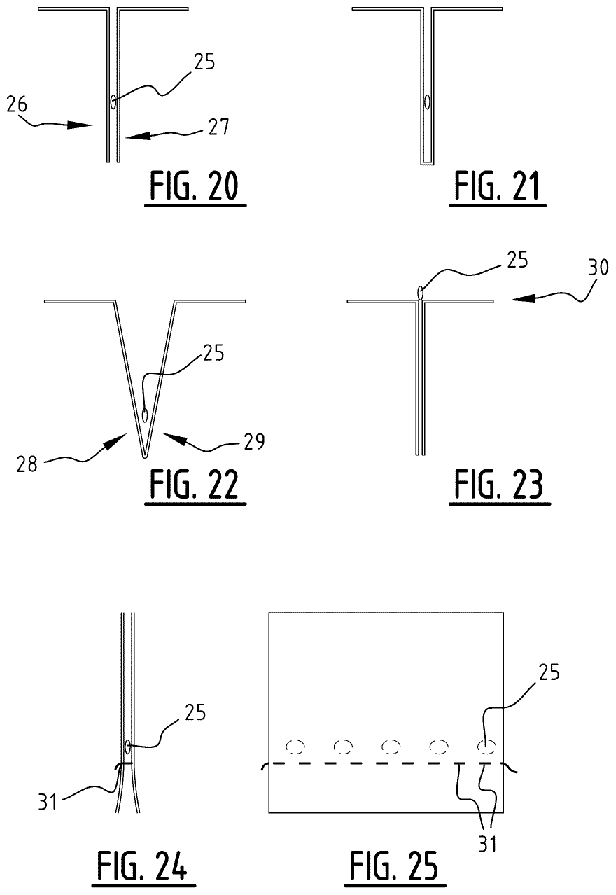

FIG. 15 resembles the embodiment of FIG. 3 but has a seed tape instead of a sowing platform. An alternative configuration of a platform is shown in FIG. 16. FIGS. 17 to 19 show alternative embodiments of gutters with a platform tape.

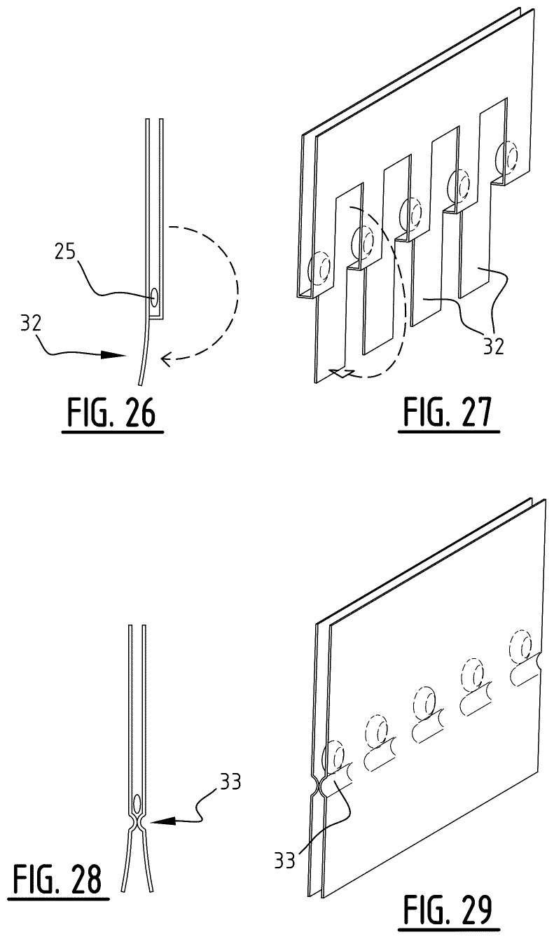

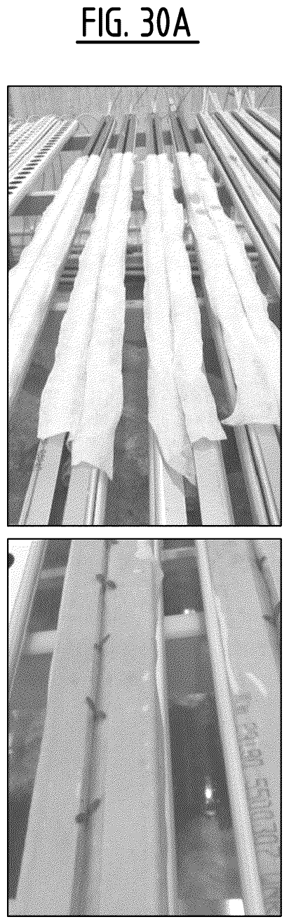

FIGS. 20 to 24 show different configurations of the tape in cross-section. FIG. 20 is a T-shape in which the seeds 25 are fixed between the two layers 26 and 27. In FIG. 21, the tape is folded in half and the seed is located at a position about halfway the part that is held together. In FIG. 22 the tape is also folded in half, but the seed is clamped between the sidewalls 28 and 29 of the V-shape. In FIG. 23, the tape forms a platform, and the seed 25 is located on the top 30 thereof. In FIG. 24, the seed is prevented by falling through by a stitch 31.

FIGS. 26 and 27 show a cross-sectional and perspective view, respectively, of a folded tape with cut-outs 32 that are folded down to make contact with the nutrient solution.

FIG. 25 shows that the two layers are held together by stitches 31 that are large enough to allow the developing root between them to grow to the nutrient solution. In FIGS. 28 and 29 the two layers are sealed. The sealing 33 is not continuous but rather comprises separately sealed patches.

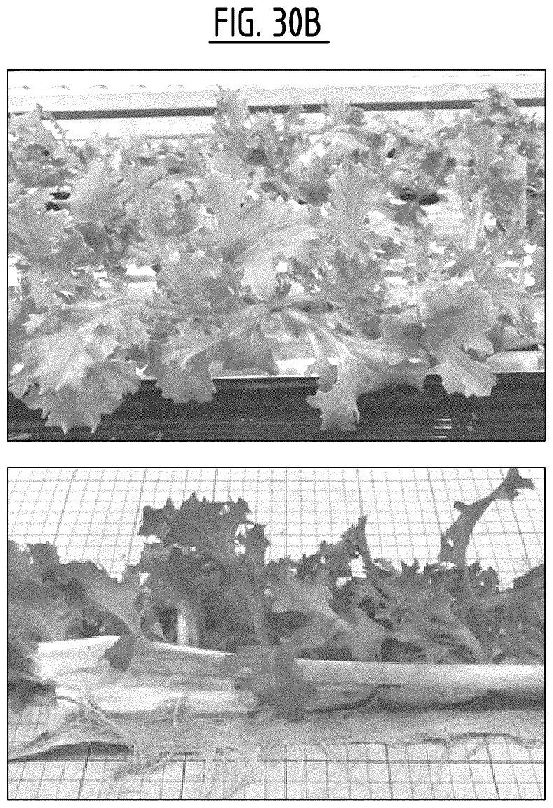

FIGS. 30A and B shows the invention in practice. The upper panel of FIG. 30A shows gutters in which seed tapes are positioned upright. The part extending beyond the gutter is folded over to both sides and rests on the gutter. By wetting the tape either from the bottom up or by spraying on the folded parts, it is adhered to the gutter to keep it in place. The seed tape comprises lettuce seeds at a pre-determined distance from each other. The lower panel of FIG. 30A shows the tapes after the seeds have germinated and have developed into a seedling. The upper panel of FIG. 30B shows lettuce plants in the so-called toddler stage while still positioned in the gutter. The bottom panel of FIG. 30B shows the tape with the plants after it has been removed from the gutter showing the well-developed root system.

FIG. 31 shows an alternative way of preparing a seed tape before positioning in the gutter. The tape comprising the seeds is rolled up and placed in a container. Either prior to after placement in the container the tape is wetted, and the seeds are allowed to germinate in the container. The container may be covered during the process of germination. After the seeds have developed into seedlings of a desired size the tape can be positioned in the container, for example by pulling the tape through the gutter starting from one side of the gutter.

The invention is further described by the following numbered paragraphs:

1. A growing system for hydroponics, comprising a gutter and a tape, wherein the gutter is open at the top and comprises a receptacle for a fluid that extends along the longitudinal direction of the gutter and wherein the tape is fixed in the gutter in an upright position in the longitudinal direction of the gutter and partially extends beyond the open top and wherein the tape is for holding or supporting propagating material.

2. The growing system of paragraph 1, wherein the propagating material comprises seeds, germinated seeds, seedlings, plantlets or cuttings.

3. The growing system of paragraph 1 or 2, wherein in use the tape is in contact with a fluid in the receptacle for wicking the fluid through the tape.

4. The growing system of paragraph 3, wherein the tape comprises at least two layers that are partially held together but are preferably not held together at the part that extends beyond the open top of the gutter.

5. The growing system of paragraph 4, wherein the at least two layers are held together by gluing the layers together, by sewing the layers together, by fusing the layers by means of heat, by folding, or by clamping.

6. The growing system of any one of paragraphs 1-5, wherein the tape is a seed tape comprising a number of seeds located along its length, preferably at a predetermined distance from each other.

7. The growing system of paragraph 6, wherein the seeds are located in between the at least two layers at a position where the layers are held together.

8. The growing system of paragraph 6 or 7, wherein the layers are held together such that the seeds once germinated are able to emerge from between the layers.

9. The growing system of any one of paragraphs 1-3, wherein the tape forms a platform for supporting seeds or germinated seeds.

10. The growing system of any one of paragraphs 1-3, wherein the tape comprises pockets for holding seedlings, plantlets or cuttings.

11. The growing system of any one of paragraphs 1-10, wherein the tape is fixed in the gutter by clamping means located at the open top.

12. The growing system of any one of paragraphs 1-3, wherein the tape is fixed in the gutter by adherence of the at least two layers extending beyond the open top of the receptacle to the gutter.

13. The growing system of any one of paragraphs 1-12, wherein the gutter is provided along its length with a guiding element extending from one side of the open top into the gutter interior.

14. The growing system of any one of paragraphs 1-13, wherein the propagation material comprises seeds, germinating seeds, seedlings, plantlets or cuttings of vegetables in particular, leafy vegetables, more in particular lettuce.

15. A method for growing plants, comprising providing plant propagation material in the growing system of any one of paragraphs 1-14 and allowing the propagation material to develop into plants, preferably until harvest stage.

16. The method of paragraph 15, comprising the steps of
a) providing propagation material held in or supported by a tape located upright in a gutter with an open top, wherein the tape comprises at least two layers partially extending beyond the open top, wherein the tape is fixed in the gutter by adherence of the at least two layers of the part of the tape extending beyond the open top to the outside of the gutter; and
b) allowing the propagation material to grow into harvestable plants.

17. The method of paragraph 15 or 16, wherein the plants are vegetable plants.

18. The method of paragraph 17, wherein the vegetable plants are leafy vegetable plants.

19. The method of paragraph 18, wherein the leafy vegetable plants are lettuce plants.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

1. A growing system for hydroponics, comprising a gutter and a tape;
wherein the gutter comprises:
a plurality of walls extending in a longitudinal direction and defining a receptacle configured to receive a fluid; and
a top comprising an opening into the receptacle, said opening extending along the longitudinal direction of the gutter;
wherein the tape comprises:
a length fixed to the gutter, said length extending along the longitudinal direction of the gutter;
a portion extending into the opening of the gutter and into the receptacle;
and
wherein the tape supports or holds a plant propagation material.

2. The growing system of claim 1, wherein the plant propagation material comprises seeds, germinated seeds, seedlings, plantlets or cuttings.

3. The growing system of claim 1, wherein the tape is in contact with the fluid in the receptacle, whereby the fluid is wicked through the tape by capillary action.

4. The growing system of claim 3, wherein the tape comprises at least two layers that are held together and wherein the plant propagation material is disposed at a position between where the at least two layers are held together.

5. The growing system of claim 4, wherein the at least two layers are held together by gluing the layers together, by sewing the layers together, by fusing the layers by means of heat, by folding, or by clamping.

6. The growing system of claim 1, wherein the tape is a seed tape comprising a plurality of seeds located along the length of the tape.

7. The growing system of claim 6, wherein the tape holds or supports the plurality of seeds at a position between where at least two layers of the tape are held together.

8. The growing system of claim 7, wherein a seal holding the at least two layers together is not continuous, whereby roots and cotyledons of germinated seeds are able to emerge from between the at least two layers.

9. The growing system of claim 1, wherein the tape comprises at least two layers that overlap with each other to form a platform configured to support or hold the plant propagation material.

10. The growing system of claim 9, wherein the at least two layers that overlap with each other form a horizontal plane equal that is flush with a horizontal plane of the top of the gutter.

11. The growing system of claim 1, wherein the tape is fixed to the gutter by clamping means located at the opening at the top of the gutter.

12. The growing system of claim 1, wherein the tape is fixed to the gutter by adherence of a portion of the at least two layers of the tape that extend beyond the opening of the top of the gutter.

13. The growing system of claim 1, wherein the gutter further comprises a guiding element extending along the longitudinal direction of the gutter, wherein the guiding element extends from along one side of the opening of the top of the gutter into the receptacle.

14. The growing system of claim 1, wherein the plant propagation material comprises seeds, germinating seeds, seedlings, plantlets or cuttings of vegetable plants.

15. A method for growing plants, comprising providing plant propagation material in the growing system of claim 1 and allowing the plant propagation material to develop into plants.

16. A method for growing harvestable plants comprising the steps of:
a) providing a plant propagation material held in or supported by a tape that is fixed to a gutter,
wherein the gutter comprises:
a plurality of walls extending in a longitudinal direction and defining a receptacle configured to receive a fluid; and
a top comprising an opening into the receptacle, said opening extending along the longitudinal direction of the gutter:
wherein the tape comprises:
a length fixed to the gutter, said length extending along the longitudinal direction of the gutter;
a portion extending into the opening of the gutter and into the receptacle;
at least two layers extending beyond the opening of the top of the gutter;
and wherein the tape is fixed to the gutter by adherence of a portion of the at least two layers of the tape that extend beyond the opening of the top of the gutter;
b) irrigating the fluid through the receptacle;
c) nourishing the plant propagation material by contacting the tape with the fluid, whereby the fluid is wicked through the tape via capillary action to contact the plant propagation material; and
d) allowing the plant propagation material to grow into harvestable plants.

17. The method of claim 15, wherein the plants are vegetable plants.

18. The method of claim 17, wherein the vegetable plants are leafy vegetable plants.

19. The method of claim 18, wherein the leafy vegetable plants are lettuce plants.

20. The method of claim 16, wherein the plant propagation material comprises seeds.

21. The method of claim 20, wherein the seeds are lettuce seeds.

22. The growing system of claim 13, wherein the guiding element forms an angle between 10 and 80° with respect to one of the plurality of walls of the gutter.

23. The growing system of claim 22, wherein the guiding element forms an angle between 30 and 70° with one of the plurality of walls of the gutter.

24. The growing system of claim 22, wherein the guiding element forms an angle between 45 and 55° with one of the plurality of walls of the gutter.

25. The growing system of claim 14, wherein the vegetable plants are leafy vegetable plants.

26. The growing system of claim 25, wherein the leafy vegetable plants are lettuce plants.
